(19) United States
(12) Patent Application Publication
(10) Pub. No.: US 2005/0039365 A1
(43) Pub. Date: Feb. 24, 2005

(54) Tire display placard

(76) Inventor: Vincente Rosa, Ozone Park, NY (US)

Correspondence Address: John H. Thomas, P.C., 1561 East Main Street, Richmond, VA, 23219, US

(21) Appl. No.: 10/644,147

(22) Filed: Aug. 20, 2003

(51) Int. Cl. G09F 3/20

(52) U.S. Cl. 40/649

(57) ABSTRACT

A tire display placard includes a belt, a bracket and a graphic holder panel. The bracket is adapted to be secured to a tire by the belt. The panel is releasably connected to the bracket. The panel may be rotatably connected to the bracket to allow written indicia on the panel to be rotatable around.

The present invention relates to a tire display placard. Specifically the invention is an apparatus that mounts to a tire and includes a display panel.

### BACKGROUND OF THE INVENTION

Wholesale and retail display of tires for sale is historically very unsophisticated. Typically, tires are stacked or displayed in different fashions. Those tire displays may be accompanied by a written description, specification, price, etc. displayed on a proximate wall plaque or stand-alone cardboard poster. In some cases, there may be sticker or decal on the tire itself displaying information regarding the tire or its price. Unfortunately, the tires themselves can be a difficult substrate on which to adhere a decal or other written material.

### SUMMARY OF THE INVENTION

Accordingly, it is object of the present invention to overcome the drawbacks with prior tire display systems. The present invention is a simple solution wherein a display panel is connected to a bracket that is further attached and mounted directly onto a tire with a belt. In this way, information regarding a specific tire can be mounted on the tire itself.

In one embodiment, a tire display placard comprises a belt having a fastening device. A bracket comprises a slot adapted to allow the belt to be threaded therethrough and also comprises a mounting aperture. A graphic holder panel comprises a front surface adapted to display written indicia and a back surface comprising a male extension adapted to be removably inserted into the mounting aperture of the bracket. The tire display placard may further include a plug adapted to engage the male extension of the panel and releasably secure the panel to the bracket. The male extension of the panel and the mounting aperture may be substantially round so that the panel is rotatably connected to the bracket by the male insert's engagement with the portion of the bracket defining the aperture. The fastening device may comprise a hook secured to one end of the belt and a plurality of holes in the opposite end of the belt from the hook. In this way, the length of the belt may be varied by inserting the hook into different ones of the holes. The bracket may further comprise a plurality of prongs on the side of the bracket opposite the side of the bracket onto which the graphic holder panel is mounted. The belt may be comprised of a rubber strap or an elastic strap.

In an alternative embodiment, a tire display placard comprises a belt having a means for fastening. The display placard may further include a bracket comprising means for receiving the belt, the bracket further comprising means for mounting a graphic holder panel. A graphic holder panel may comprise a front surface adapted to display written indicia and a back surface comprising means for connecting the panel to the mounting means. The mounting means and connecting means may be substantially round. The belt may be comprised of an elastic strap and it may further be comprised of means for adjusting its length.

### BRIEF DESCRIPTION OF THE DRAWINGS

FIG. 1 is an exploded, perspective view of an embodiment of a tire display placard in accordance with the present invention.

FIGS. 2A and 2B are bottom and side views respectively of a graphic holder panel in accordance with an embodiment of the present invention.

FIGS. 3A and 3B are bottom and side views respectively of a bracket in accordance with one embodiment of the present invention.

FIGS. 4A and 4B are top and side views respectively of a plug in accordance with an embodiment of the present invention.

FIG. 5 is a side elevation, cross sectional view of an assembly including a graphic holder panel, bracket and plug in accordance with an embodiment of the present invention.

FIG. 6 is a perspective view of a tire display placard in accordance with an embodiment of the present invention as mounted onto a tire.

### DETAILED DESCRIPTION

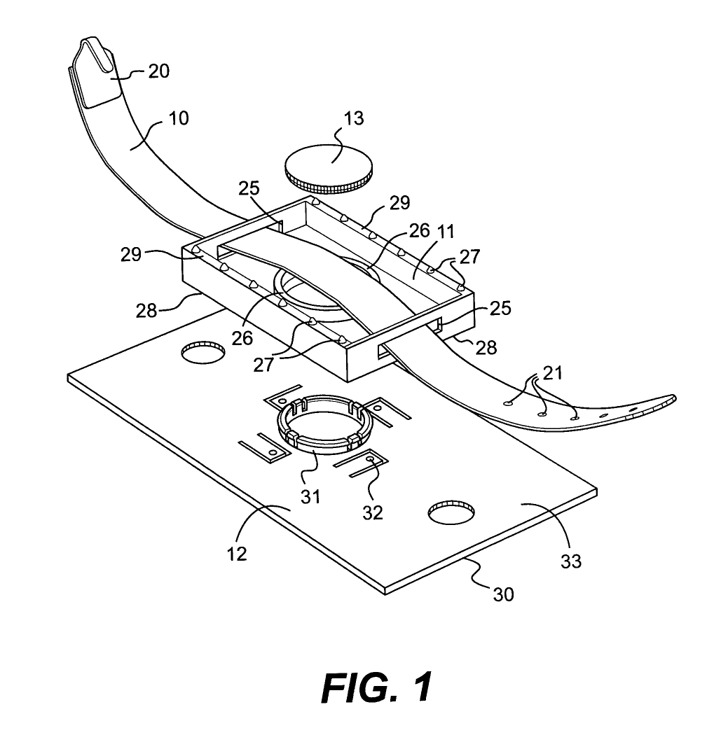

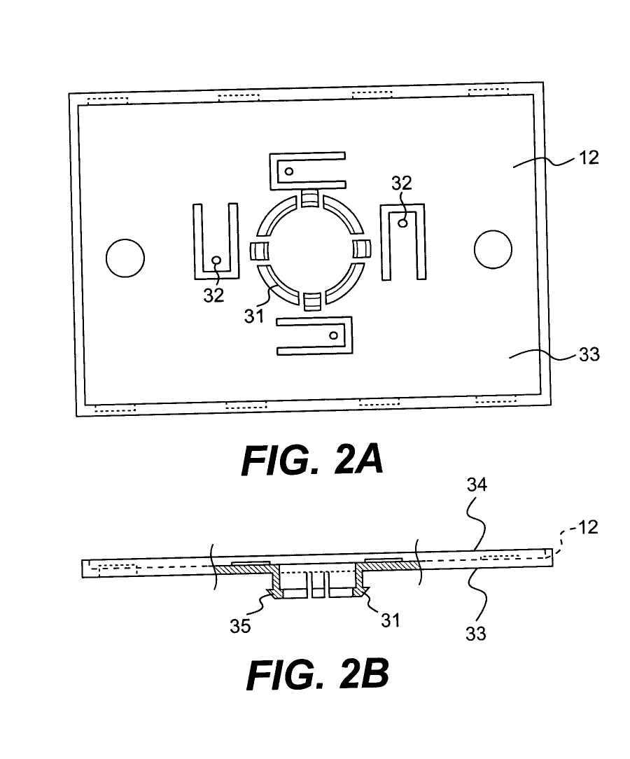

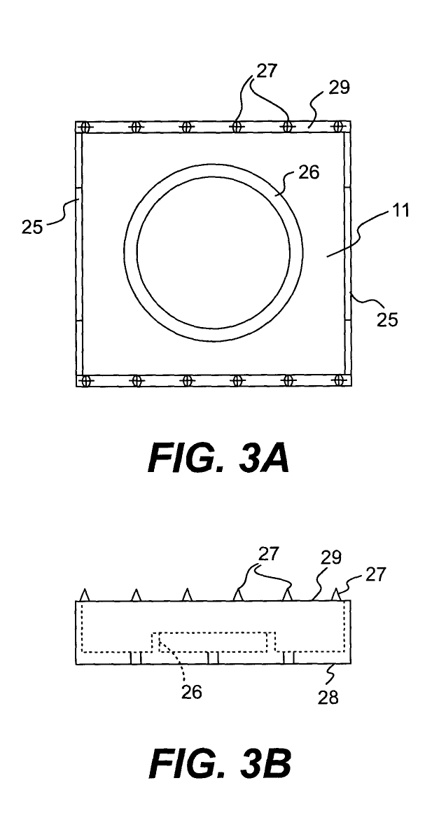

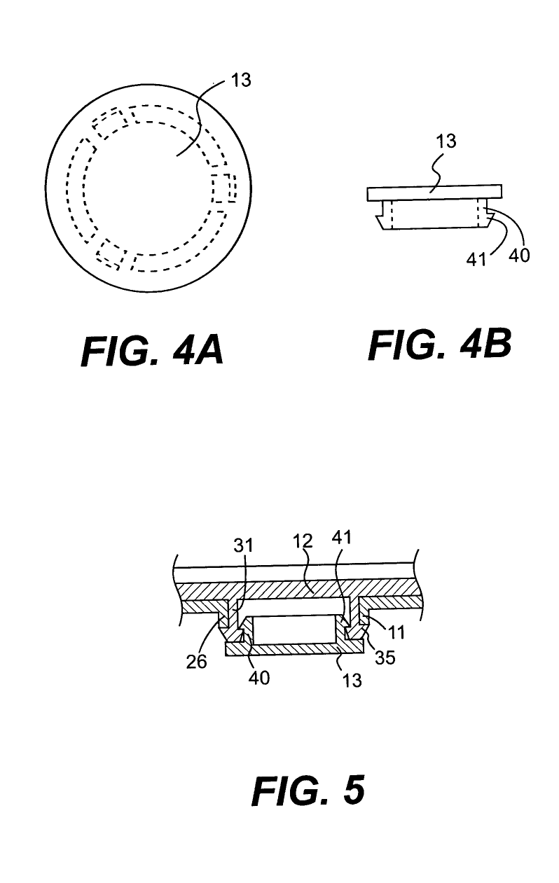

FIG. 1 displays a perspective view of a tire display placard comprised in primary components of a belt 10, a bracket 11, a graphic holder panel 12, and a plug 13. Bracket 11, graphic holder panel 12 and plug 13 are shown in more detail in FIGS. 2A-5. The like numbers reference the like aspects and components of those primary features of the tire display placard.

The belt 10 is the component which effectively attaches the entire placard assembly to a tire. The belt 10, in one embodiment, is made of an elastic material such as rubber. The belt 10 includes a fastening device that, as shown in FIG. 1, is a hook 20 attached to one end of the belt and holes 21 formed in the other end of the belt. The belt 10 is wrapped around a tire and the hook 20 is inserted into a correct hole 21 that is appropriate for the given diameter of the tire about which the placard assembly will be mounted. Other fastening devices may be used to adjust the length of the belt including, for instance, a hook and loop type fasteners, or snaps, or any other similar device for fastening. In one embodiment, the belt is approximately one inch wide and is made of 3/32 of an inch thick rubber.

The bracket 11 serves two primary purposes. The bracket 11 includes a slot 25 or slots to receive the belt 10 in order to secure it around a tire. The bracket 11 further is the base onto which a graphic holder panel 12 is removably attached. As shown, the bracket 11 includes two slots 25 that receive the belt 10. As noted, only one, or alternatively, three or more slots could be used in order to receive the belt 10 and secure the bracket 11. The bracket 11 further defines a mounting aperture 26. As shown, the aperture 26 is substantially circular; however, it could be made of any shape. The overall bracket 11 is shown in this embodiment as being generally rectangular. However, the bracket 11 could be any shape. The bracket 11 includes a first surface 28 that is adjacent the graphic holder panel 12. A second surface 29 is adjacent a tire when mounted onto a tire. Prongs 27 are molded or fixed into the bracket 11 along the face of the second surface 29 in order to securely grip onto the surface of a tire.

The graphic holder panel 12 is made up of a front surface 34 and back surface 33. The front surface 34 is adapted to display written indicia, typically an advertisement, specification, or other written material regarding the tire onto which the apparatus is mounted. The front surface 34 is shown as rectangular in shape in this embodiment, but it may be any shape. The front surface 34 is shown as being flat in this embodiment, but it may alternatively be curved or textured in order to impart any desirable marketing or advertising effects. The written indica may include simple written terms, or it may include more involved graphics detail. The back surface 33 of the panel 12 includes a male extension 31 that is adapted to be removably inserted into the mounting aperture 26. The extension 31 includes an annular lip 35 which provides a friction fit and locking effect with the aperture 26. An exemplary interconnection between the male extension 31 and the aperture 26 is demonstrated in FIG. 5. Bumps 32 are also molded into the back surface 33 of the panel 12. These bumps 32 will come into contact with the front surface 28 of the bracket 11 and prevent the free rotation of the panel 12.

The plug 13 is shown as being circular in shape. Of course, any shape that locks the plug 13 with the panel 12 into the bracket 11 may be used. The plug 13 has an extension 40 that includes an annular lip 41 that locks the plug 13 into place with the extension 31 of the graphic holder panel 12. Again, an example of the interconnection of the plug 13 with the graphic holder panel 12 and bracket 11 is shown in FIG. 5.

As demonstrated in the embodiment shown, the aperture 26 and male extension 31 are circular to allow the rotation of the graphic holder panel 12. In this way, the panel 12 may be rotated around with respect to the tire onto which the entire apparatus is mounted. In other words, in the example of a rectangular panel 12 as shown, the panel 12 may be rotated into a generally horizontal or a generally vertical position. Other shapes of the graphic holder panel may also be used and the circular interconnection allows for that free rotation for display purposes.

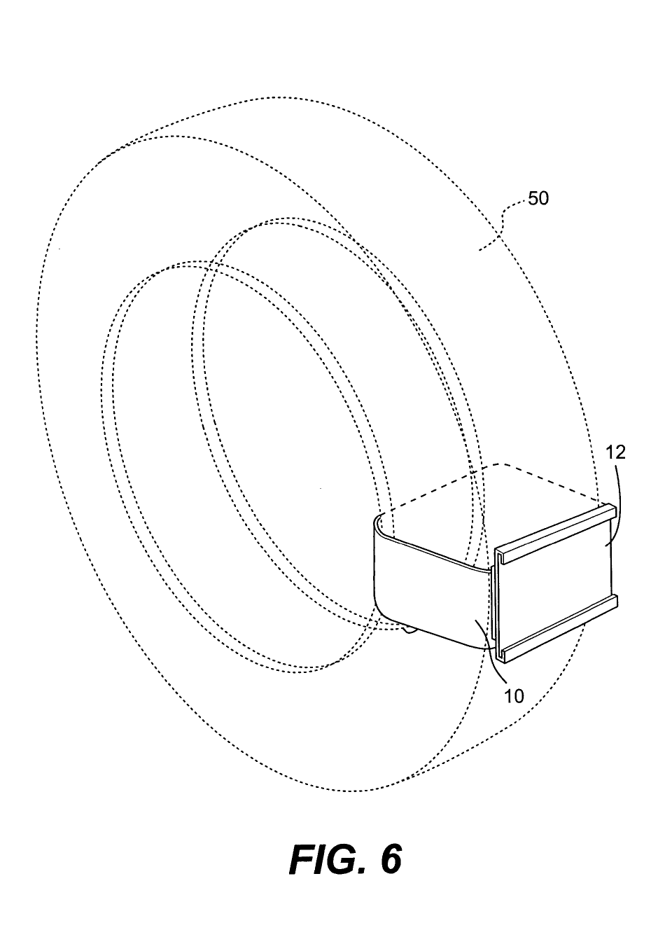

FIG. 6 illustrates a display placard as it would appear on a tire shown in broken lines. The graphic holder panel 12 is visible to a potential purchaser. The belt 10 is sized according the dimensions of the tire 50.

While the invention has been described with reference to specific embodiments thereof, it will be understood that numerous variations, modifications and additional embodiments are possible, and accordingly, all such variations, modifications, and embodiments are to be regarded as being within the spirit and scope of the invention.

1. A tire display placard comprising:
a belt having a fastening device;
a bracket comprising a slot adapted to allow the belt to be threaded through it, the bracket further comprising a mounting aperture; and
a graphic holder panel comprising a front surface adapted to display written indicia and a back surface comprising a male extension adapted to be removably inserted into the mounting aperture of the bracket.

2. A tire display placard as described in claim 1, further comprising a plug adapted to engage the male extension of the panel and releasably secure the panel to the bracket.

3. A tire display placard as described in claim 1, wherein the male extension of the panel and the mounting aperture are substantially round, and the panel is rotatably connected to the bracket by the male insert's engagement with a portion of the bracket defining the aperture.

4. A tire display placard as described in claim 2, wherein the male extension of the panel, the mounting aperture, and the plug are substantially round, and the panel is rotatably connected to the bracket by the plug's engagement with the male insert through the mounting aperture.

5. A tire display placard as described in claim 1, wherein the fastening device comprises a hook secured to one end of the belt and a plurality of holes in the opposite end of the belt from the hook, whereby the length of the belt may be varied by inserting the hook into different ones of the holes.

6. A tire display placard as described in claim 1, wherein the bracket further comprises a plurality of prongs on the side of the bracket opposite the side of the bracket onto which the graphic holder panel is mounted.

7. A tire display placard as described in claim 1, wherein the belt is comprised of a rubber strap.

8. A tire display placard as described in claim 1, wherein the belt is comprised of a elastic strap.

9. A tire display placard comprising:
a belt having a means for fastening;
a bracket comprising means for receiving the belt, the bracket further comprising means for mounting a graphic holder panel, and
the graphic holder panel comprising a front surface adapted to display written indicia and a back surface comprising means for connecting the panel to the mounting means.

10. A tire display placard as described in claim 9, wherein the mounting means and connecting means are substantially round, and the connection of the panel to the bracket is rotatable.

11. A tire display placard as described in claim 9, wherein the belt is comprised of an elastic strap.

12. A tire display placard as described in claim 9, wherein the belt comprises means for adjusting its length.
